(19) United States
(12) Patent Application Publication
(10) Pub. No.: US 2005/0108069 A1
(43) Pub. Date: May 19, 2005

(54) System and a method for prefetching travel information

(76) Inventors: Tomer Shiran, Haifa (IL); Yehuda Shiran, Haifa (IL); Ari Shotland, Haifa (IL); Oren Naim, Zichron Yaakov (IL)

Correspondence Address: DANIEL J SWIRSKY, PO BOX 2345, BEIT SHEMESH, 99544, IL

(21) Appl. No.: 10/714,635

(22) Filed: Nov. 18, 2003

(51) Int. Cl. G06F 17/60

(52) U.S. Cl. 705/5

(57) ABSTRACT

A system and a method is disclosed for prefetching travel information relevant to travel products from travel suppliers, prior to a process of making travel reservations by users. The system includes a prefetcher for retrieving the travel information. The system also includes a cache for storing the travel information retrieved by the prefetcher and a front-end wherein the system is able to receive queries from the user and respond to the queries. Prefetching creates a comprehensive cache having a substantially high probability of containing the travel information that the user needs.

### FIELD OF THE INVENTION

The present invention relates generally to a system and a method for travel reservations. More particularly, the present invention relates to a system and a method for prefetching information prior to a process of making travel reservations.

### BACKGROUND OF THE INVENTION

The global travel industry relies on the distribution of data. Travel suppliers (e.g., American Airlines, Hyatt, Hertz) need to distribute their inventories so that up-to-date information is available at the fingertips of travelers and travel agents. The travel industry has been one of the fastest to adopt e-commerce, and has therefore become dependent on related technological progress.

Traditionally, even before e-commerce, travel suppliers 121-123 have used Global Distribution Systems (GDS's) 130 to distribute their inventory, as shown in prior art FIG. 1a. Some well known GDS providers, also known as Computer Reservation Systems, or CRS's, are Worldspan, Amadeus, Galileo and Sabre. The strong competition in the travel industry is forcing travel suppliers 121-123 to reduce the distribution costs, and one way of doing that is eliminating the GDS 130 from the supply chain, as shown in prior art FIG. 1b. Therefore, some travel suppliers, such as airlines 121, car rental companies 122 and hotels 123, are already providing direct distribution via technologies such as Web services over the Internet 150. Travel systems 140, such as online travel agents, can utilize these services to bring travel inventory to their customers 110.

The introduction of direct distribution channels poses various technological challenges. For example, without direct distribution, online travel agents usually have to receive their inventory from a single source—a GDS, or possibly a few different GDS's. The online travel agent then performs all queries against this source. In this model, the GDS has a big database with all the travel inventory of the travel suppliers that work with that GDS. The GDS is responsible for maintaining the database, and can provide information to online travel agents via a pre-defined interface. Actions, such as booking a flight or reserving a hotel, are also handled by the GDS.

The term travel product hereinafter refers to a flight segment, an entire flight (including at least one flight segment), a hotel stay, a car rental, or any other travel unit. However, a travel product isn't necessarily a priced unit—for example, a collection of flight segments forming a single flight is usually priced independently. A hotel stay, for instance, includes not just the hotel name, but also the dates, room type, etc.

In the direct-distribution world, things are a bit more difficult. An online travel agent has to query each travel supplier independently. For example, if a customer wants to see a list of flights from Tel Aviv to New York, the online travel agent has to send the request, e.g., a Web service request to American Airlines, El Al and all the other airlines servicing this route. The agent then has to wait for all the suppliers to respond. This process can be time and resource-consuming, and is usually impractical when an immediate response must be given to the user (typically the potential customer). A possible solution to this problem could be data caching, but that could be problematic due to the large number of different travel products.

A major travel market segment is corporate travel. In today's global economy, most companies need to spend a lot on travel. In fact, after salaries, travel is the second largest expense for corporations. In addition, most companies have a limited set of destinations to which their employees travel. For example, Intel employees travel to Haifa, Santa Clara, Portland and several other sites. Therefore, when thinking about a specific company, an agent's array of travel products is relatively small. Furthermore, companies usually impose travel policies, which further narrow the range of travel products that they consume.

Another interesting fact is that many companies have their own online travel system, which is used by employees to find and order travel products. Large companies often host their own travel systems on an Intranet, or internal corporate network, while others co-host their sites with other companies. Various companies, such as GetThere and TRX, provide the software solutions for these scenarios. As dictated by the nature of these scenarios, a single system is usually used by one or several companies. This implies that the system normally deals with a rather narrow range of products, based on the needs of the specific company or companies that it serves.

Therefore there is a need for a system and a method that overcomes the limitations of the prior art, and provides a system and a method that uses prefetching to improve the performance of organizational travel systems.

### SUMMARY OF THE INVENTION

Accordingly, it is a principal object of the present invention to overcome the limitations of prior art, and to provide a system and a method that uses prefetching to improve the performance of organizational travel systems. It is another principal object of the present invention to cache the travel information such that prefetching the travel information creates a comprehensive cache, having a substantially high probability of containing the travel information that the user needs.

A system and a method is disclosed for prefetching travel information relevant to travel products from travel suppliers, prior to a process of making travel reservations by users. The system includes a prefetcher for retrieving the travel information. The system also includes a cache for storing the travel information retrieved by the prefetcher and a front-end wherein the system is able to receive queries from the user and respond to the queries. Prefetching creates a comprehensive cache having a substantially high probability of containing the travel information that the user needs.

Prefetching refers to performing work in anticipation of future needs. Prefetching Web pages is discussed in chapter 12 of the book “Web Caching and Replication” by Michael Rabinovich and Oliver Spatscheck. However, prefetching travel data is very different from prefetching Web pages.

Again, organizations usually have a defined set of destinations such that almost all of the flights, for example, that interest the company have a destination that belongs to that set. For example, a company XYZ has three different sites in the world: TLV, BOS, and SFO. This implies that almost all of the flights that interest the company belong to the following set: {Tel Aviv->Boston, Tel Aviv->San Francisco, Boston->Tel Aviv, Boston->San Francisco, San Francisco->Tel Aviv, San Francisco->Boston}. That's obviously much less than the total number of destination tuples that exist.

Assume that company XYZ has no travel policies, which is quite unlikely in practice. In this case, the prefetcher should contact each travel supplier via a predefined protocol that the supplier provides, to retrieve the flights between the above set of destinations. As implied by the term “prefetch,” this is not done in response to a search conducted by an XYZ employee. Instead, the data is fetched before hand, say on a regular schedule, and is stored in the cache. When an employee requests travel information via the system's front-end, the desired information (or at least most of it) is likely to be immediately available.

Users are typically employees of a corporation or any group or organization having a similar list of regular destinations and/or travel policies. Usually, a company has various travel policies that employees must obey when making reservations. Sometimes, there is a designated person in the company that is responsible for reservations. Travel policies actually create restrictions which further reduce the total range of products that need to be prefetched. For example, a company could require its employees to fly with one of 5 specific airlines. It could also require all employees to fly Economy class. Such restrictions can make the process of prefetching less time and resource-consuming.

The range of relevant travel products applies not only to flights, but to all travel products. For example, company XYZ would probably only be interested in hotels located in Tel Aviv, Boston, and San Francisco. Furthermore, the company could require all employees to stay in one of 3 different hotels in each of these cities, with which the company has special discount arrangements. Alternatively, or additionally, the company could require employees to stay in hotels with a rate of under $100 per night. Such restrictions can dramatically reduce the range of relevant products.

Note that the prefetcher can be invoked based on any desired specification. For example, it could be scheduled to run at night, when network bandwidth and computing power is available. Another option could be a manual invocation. For example, if a travel agent or travel administrator at the company adds a new location or a new set of restrictions, it would make sense to run the prefetcher again. So the decision of when to prefetch actually can depend on many criteria. It may be done at regular intervals, based on a set of conditions or according to operator discretion, or any combination of these.

Also, since the total range of relevant travel products could still be quite large even after reducing it as explained in previous paragraphs, it could make sense to prefetch some sub-ranges more often than others. Deciding what to prefetch also depends on various parameters. For example, the system could take advantage of the stored history of employee reservations. For example, if history shows that company XYZ's employees usually fly with El Al when traveling from Tel Aviv to Boston, it would make sense to prefetch flight information from El Al more than other airlines. Doing this is easy, since the system contacts each supplier independently, according to the particular protocol used by the supplier. The prefetcher prefetches both travel products, such as segments and flights (ordered lists of segments), and predefined sets of travel products. A predefined set may include, for example, a flight of American Airlines that includes several segments (TLV to BOS, BOS to PDX, SJC to DFW, DFW to ZRH and ZRH to TLV) and Alaska Airlines for a single segment (PDX to SJC). This set may also include hotels and car rentals for all stops. During prefetching, the system refreshes such predefined sets in the cache. It sends a query for each travel supplier and updates price and availability in the cache (see FIG. 3a).

Additional features and advantages of the invention will become apparent from the following drawings and description.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

FIG. 1a is a prior art schematic block diagram illustration of the traditional GDS flow of travel information;

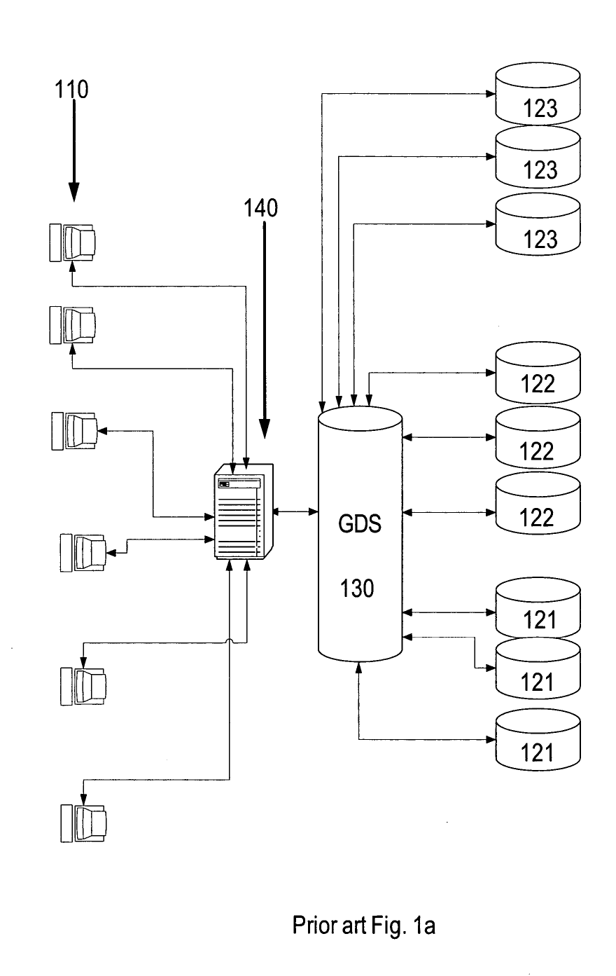

FIG. 1b is a prior art schematic block diagram illustration of the more recent non-GDS flow of travel information;

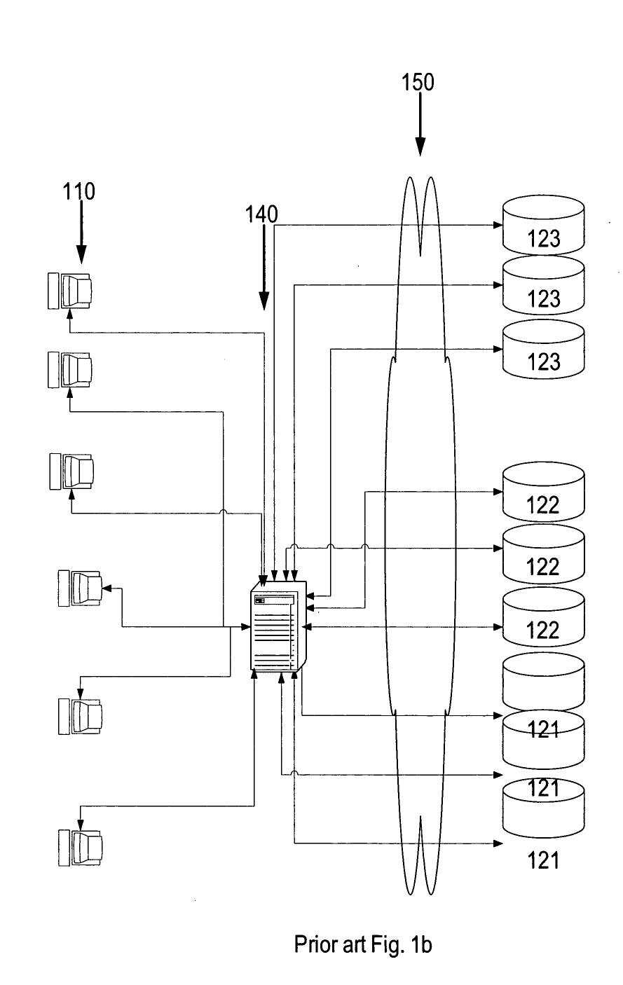

FIG. 2 is a schematic block diagram illustration of the prefetching system for travel information for users, constructed in accordance with the principles of the present invention;

FIG. 3a is a flowchart for prefetching flights, constructed in accordance with the principles of the present invention; and

FIG. 3b is a flowchart for prefetching predefined sets of travel products, constructed in accordance with the principles of the present invention.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art. References to like numbers indicate like components in all of the figures.

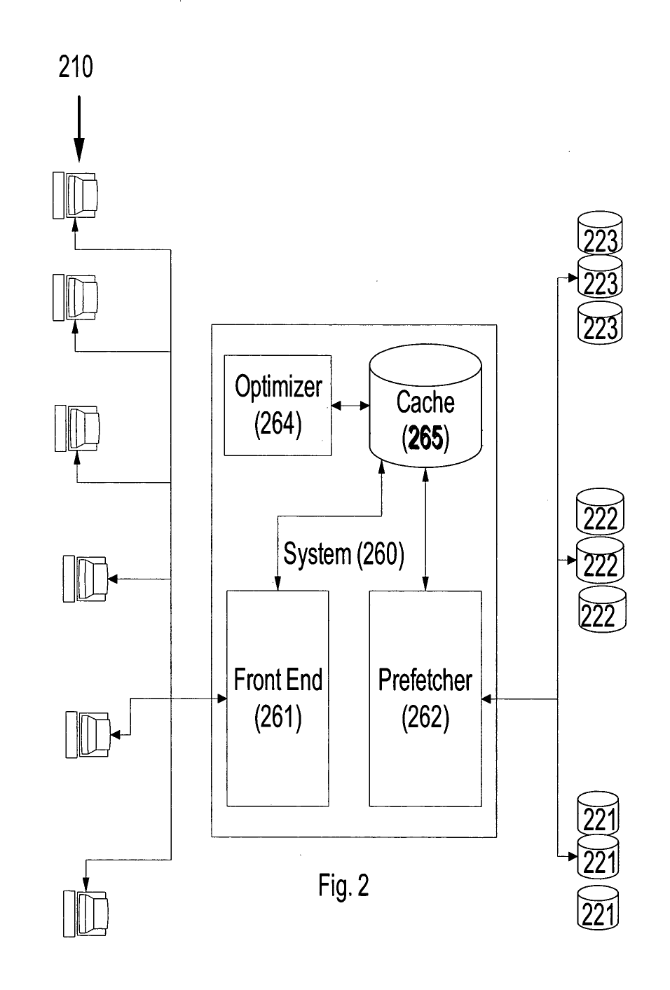

Reference is made now to FIG. 2, which is a schematic block diagram illustration of the online prefetching system for travel information 260 for users 210, constructed in accordance with the principles of the present invention.

Prefetching can have the following advantages for the travel information handling process:
1) If travel information is accessed by a prefetcher 262 and stored in a cache 265, system 260 is able to quickly respond to queries received by a front-end 261 from users 210. In a system without prefetching, it would take a lot of time to fetch all the necessary information from all the suppliers (221, 222, 223) on an on-demand basis.
Prefetcher 262 behaves according to configurable parameters. In other words, it fetches information when various defined events (e.g., time-based events and user-initiated events) occur.
2) Once a system has prefetched all/enough of the travel information that it needs, it can look for optimizations. Due to the complex pricing model used by travel suppliers, it is often possible to find less expensive products by combining several products, selecting a product that was initially intended for different use (e.g., it is possible that a round-trip flight between two destinations is cheaper than a one-way flight, so when searching for such a one-way flight, the system should include the cheaper round-trip flight in the search results) and various other techniques that are currently employed only by human travel agents. By prefetching, system 260 can create a local replica of the travel data that is relevant to an organization. It can take advantage of such optimization techniques/algorithms executed by optimizer 264 to offer capabilities similar to experienced human travel agents.
System 260 could also combine products of different suppliers if it has the data of all its suppliers beforehand in cache 265.

Prefetching works as follows from the moment the prefetcher is invoked for a specific type of travel products, e.g., flights (air travel):
1) Determine the set of travel suppliers 223 that need to be queried. This might not be all the airlines, for example, if the company has a policy that enforces the use of a subset of airlines; and
2) For each travel supplier 223:
   a. Make a connection to that travel supplier (e.g., via Web services); and
   b. Based on the protocol that is defined by the specific supplier, determine what queries need to be sent (queries are typically messages) to the supplier. Note that depending on the defined protocol, it may be necessary to use multiple queries to cover the entire range. In a typical protocol, at least one query is required for each travel product.
   c. For each query that is needed, send the query and retrieve the results.
   d. Store the results in local cache 265 (some processing may be needed before storing).
   e. Terminate the connection to the supplier.

Note that step 2 isn't necessarily executed serially. It might be better to connect to all the suppliers in parallel, since the most time-consuming stage is probably waiting for the responses from the supplier.

The above steps specify how prefetcher 262 works for a specific category. System 260 has logic that executes before and after these steps as follows:
A) For each category {flights, car rentals, hotels, . . . }:
   a. Execute exemplary steps 1 and 2, which may also be applied to more general categories
   b. Run optimizations according to various techniques currently used mostly by human travel agents.
B) Execute some final logic, which can have various purposes.

For example, it could make sense to run various algorithms that create custom packages that include more than one product category, e.g., packages that contain flights, car rental, and hotels. Any other post-processing should occur at this stage. The final results of all the executed logic are obviously stored and used later by system 260 when the user requests travel information of some sort.

This is just one example of a possible flow. Alternative embodiments include:
1) Instead of retrieving the travel data in the straightforward way, system 260 could analyze the history of actual travel at the organization. Since it is a reasonable assumption that the past is an indicator of the future, it makes sense to use this information when retrieving data. For example, the system could use this information to narrow the queries that are sent to the suppliers, and thus could receive more exact information. When performing a relatively general query, the supplier is responsible for deciding what information to return to system 260. However, a more specific query forces the supplier to provide information that is of special interest to the system; and
2) It might not be necessary to prefetch the entire range of travel products that are needed each time. The system could prefetch different data at different times or as a result of different events.

Note that even though the discussion is only about searching and retrieving for travel information from separate suppliers, this technique brings many benefits even if working with a mediator such as a Global Distribution System (GDS). In such a case it makes sense to use caching, wherein the caching according to the present invention is done by prefetcher 262 in order to hold the most relevant travel information locally. This makes pre-processing possible. Pre-processing in this case refers to processing that is done at any time before the data is actually needed in order to respond to a user's request for travel information.

### EXAMPLE

### Flight Prefetching

Again, flight information is being prefetched for company XYZ. Assume that the following flights from a source (S) to a destination (D), are not necessarily direct flights, and can consist of multiple segments, but what interests the company is finding flights between S and D:
S={SFO, SJC, BOS, TLV, LAX}
D={SFO, SJC, BOS, TLV}

A flight is designated as a tuple such as (SFO, BOS), indicating an initial departure from SFO and a final arrival at BOS. So the entire range of flights that is of interest to XYZ can be specified as the Cartesian product S×D. (A tuple is a record of 2 values, in this case).

Also assume that in addition to the specification of these sources and destinations, company XYZ also applies various restrictions:
1) They do not permit their employees to fly Iran Airlines; and
2) They require their employees to fly Economy class.

Prefetcher 262 contacts the services exposed by each airline, via the airline's published protocol, and sends a query for Economy class flights that match a tuple from the Cartesian product S×D. Due to limitations on the messaging protocol with El Al, for example, it is not possible to request a specific class, so with El Al prefetcher 262 doesn't specify the class in its query, but instead filters the results.

Prefetcher 262 processes the results returned by each supplier. It can execute various algorithms that find/build flight routes that weren't directly returned by any of the suppliers. Sometimes the supplier, for various reasons, does not provide the best route for the user. For example, if a user needs a multiple destination flight from TLV to BOS, and after a few days from BOS to SFO, and a week later from SFO back to TLV, prefetcher 262, or a different component that works in conjunction with prefetcher 262 could request a flight from TLV to SFO with an intermediate stop at BOS, and this could cost much less than any other alternative, such as pricing the combination of the 3 (or more) segments as a multiple destination flight. Note that during the stage of operation of optimizer 264, prefetcher 262 might need to post additional queries to various travel suppliers in order to retrieve additional travel information that the optimizer needs.

Sometimes, when looking for a flight from S to D, it makes sense to send several different queries to a supplier. Human travel agents use this technique a lot, and base it on their knowledge and experience. For example, a flight with a stop at an airline's hub airport (each airline usually has one or more hubs, where they do most of their flights connections) could be significantly cheaper than a direct flight, but without specifically trying that option (asking the supplier specifically in a separate query) the system can't check if a lower price can be achieved using such a technique. Therefore, the prefetcher can take advantage of the fact that it isn't working under a strict deadline, such as a user waiting for a response, and try to send additional queries to the suppliers in order to “force” the supplier to provide better results.

Note that the term query that we use here isn't necessarily mapped to a single message sent to a travel supplier. Sometimes the supplier exposes a complex set of messages that the client must use in order to retrieve travel information. For example, it might not be possible to search for flight schedules and pricing with one message. A separate message might be required in order to price a flight. Furthermore, different types of information have different refresh rates. For example, an airline might update its schedule once a week, but in order to optimize its revenue it might change the flight rates every 24 hours. In this case, prefetcher 262 would not need to retrieve a supplier's flight schedule every day, but it would make sense to fetch the up-to-date rates on a daily basis. The complete picture is often composed of different data retrieved at different times from different sources, but the main principle is to prefetch all this data in order to compose the picture. It is simply not realistic to do that in real-time when the user is waiting for a response.

The following happens wherein a user wants to search for a travel product and make a reservation. When prefetcher 262 is used, local cache 265 is maintained on system 260. When user 210 requests specific travel information, system 260 first checks local cache 265 to see if it can respond immediately. System 260 must also make sure that the information in cache 265 is up-to-date. Since the most relevant travel information is prefetched regularly, there is a high chance that the information requested by user 210 already exists in cache 265. In some circumstances, it might be necessary to send a query (or several queries) to one or more suppliers even if the data is in local cache 265. For example, in order to make sure the data is up-to-date or to retrieve the latest rates for a product that is already stored in cache 265. Such a query can be very specific, because the optimal route, for example, is already known thanks to operation of prefetcher 262.

If user 210 requests information that is not already in cache 265, then online system 260 is in the same situation as a system without a prefetcher, or without any caching. A system without a prefetcher must make a connection to each travel supplier, or just one connection to a centralized database such as a GDS. It must then retrieve the necessary information and after limited processing should respond to the user. Since the system only receives the information that the supplier's service provides, as a response to a single specific query (or a relatively small set of queries), it cannot look for its own optimizations.

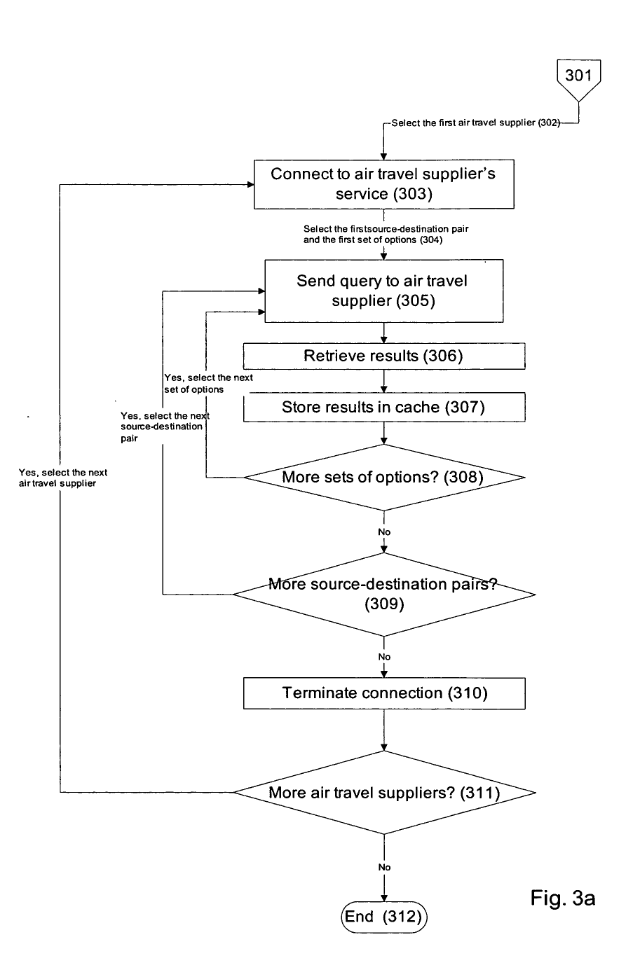

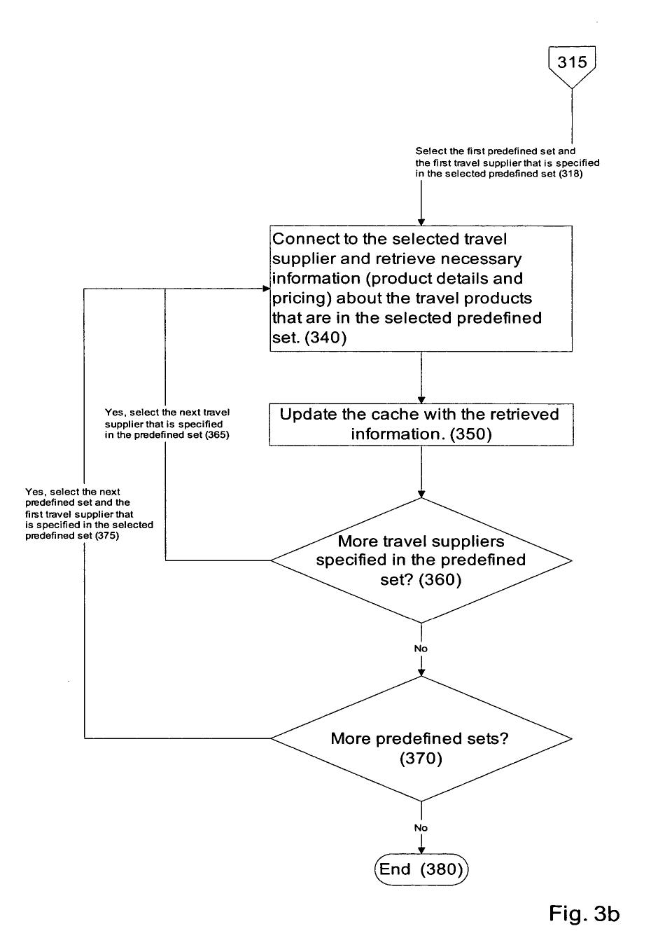

FIG. 3a is a flowchart for prefetching flights, as an exemplary travel product, constructed in accordance with the principles of the present invention. Once started 301, the first air travel supplier is selected 302. The system then connects to the selected air travel supplier 303. Then the first source-destination pair and the first set of options for that pair are selected 304 and a query is sent to the air travel supplier 305. The selected source-destination pair and the options (the options can be specifications of intermediate flight stops, cabin, meals, or any other parameter that is supported by the supplier's online service) are specified within the query according to the protocol exposed by the supplier's service.

The system then retrieves the results 306 and stores the results in the cache 307. If more sets of options are needed in order to retrieve all the required information from the selected supplier for the current source-destination pair 308, again a query is sent to the air travel supplier 305, etc. If not, it is then determined whether there are additional source-destination pairs 309. If yes, then again a query is sent to the air travel supplier 305, etc. If not, the connection is terminated 310 and it is determined whether there are additional relevant air travel suppliers 311. If so, again the system connects to the next air travel supplier 303, etc. If not, prefetching flights ends 312.

FIG. 3b is a flowchart for prefetching predefined sets of travel products, constructed in accordance with the principles of the present invention. Once started 315, the system selects the first predefined set and the first travel supplier that is specified in it 318. For each of the travel products of the selected travel supplier in the selected predefined set, the system retrieves the information associated with the travel product, such as schedules and pricing 340. It then updates the cache with the retrieved information 350.

If the selected predefined set consists of travel products from additional suppliers 360, then the next travel supplier is selected 365. If not, it is then determined whether more predefined sets exist 370. If so, the system selects the next predefined set and the first travel supplier specified in the set 375. If not, prefetching predefined sets ends 380.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

1. A system for prefetching travel information relevant to travel products from travel suppliers, prior to a process of making travel reservations by users, the system comprising:
a prefetcher for accessing the travel information;
a cache for storing the travel information accessed by said prefetcher; and
a front-end, wherein the system is able to receive queries from the user and respond to the queries,
such that said cache of the system caches the travel information, wherein said prefetching creates a comprehensive cache having a substantially high probability of containing the travel information that the user needs.

2. The system according to claim 1, wherein said front-end is embodied as a Web site.

3. The system according to claim 1, further comprising an optimizer to perform post-processing on the prefetched data.

4. The system according to claim 1, wherein said system serves one or more organizations, and said users are members of said organizations.

5. The system according to claim 1, wherein said users are travel agents that use said system to serve their customers.

6. A method for prefetching travel information relevant to travel products from travel suppliers, prior to a process of making travel reservations by users, wherein the travel information is stored in a cache, the method comprising:
determining the set of travel suppliers that need to be queried; and
performing the following for each travel supplier:
making a connection to that travel supplier;
determining what queries need to be sent to the supplier, based on the protocol that is defined by the specific supplier and the travel information that needs to be retrieved from the supplier;
performing the following for each query that is needed:
sending the query to the supplier and retrieving the results; and
storing the results in the cache; and
terminating said connection to the supplier.

7. The method according to claim 6, wherein the specific type of product is one of the following:
rental cars;
accommodations; and
air travel.

8. The method according to claim 6, wherein said protocol is based on Web services, and wherein said queries are messages that are sent to the supplier, and wherein said results are messages sent by the supplier.

9. The method according to claim 6, wherein storing involves substantial processing before said storing.

10. The method according to claim 6, wherein said travel products are of special interest to at least one organization and said users are members of said at least one organization.

11. The method according to claim 6, wherein said users are travel agents that are making reservations for their customers.

12. The method according to claim 6, wherein said travel supplier is a Global Distribution System (GDS) that supplies information for travel products from different suppliers.

13. The method according to claim 6, wherein determining what queries need to be sent involves inspecting the history of travel reservations of said users.
